(19) United States
(12) Patent Application Publication
(10) Pub. No.: US 2010/0185564 A1
(43) Pub. Date: Jul. 22, 2010

(54) METHOD AND QUESTIONNAIRE FOR MEASURING CONSUMER EMOTIONS ASSOCIATED WITH PRODUCTS

(75) Inventors: Silvia C. King, Hunt Valley, MD (US); Herbert L. Meiselman, Rockport, MA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: MCCORMICK & COMPANY, INC., Sparks, MD (US)

(21) Appl. No.: 12/691,455

(22) Filed: Jan. 21, 2010

Related U.S. Application Data
(60) Provisional application No. 61/146,221, filed on Jan. 21, 2009.

(51) Int. Cl. G06Q 90/00

(52) U.S. Cl. 705/500

(57) ABSTRACT

A method of measuring consumer emotions associated with a product comprises producing a list of emotional terms and validating emotional terms from the list that consumers use with the product. The method also includes developing a questionnaire, using the validated emotional terms, that asks the consumers to describe their feelings associated with the product and analyzing data from the completed questionnaire. The questionnaire includes a plurality of validated emotional terms associated with the product and a scale next to each of the validated emotional terms for the consumer to indicate the applicability of the emotional terms associated with the product.

### CROSS-REFERENCE TO RELATED APPLICATIONS

This application is based upon and claims the benefit of priority from prior U.S. Application Ser. No. 61/146,221, filed Jan. 21, 2009. The entire content of which is incorporated herein by reference.

### BACKGROUND

Food affects the way we feel and researchers have included mood as a key variable determining food choices. One of the clearest demonstrations of this is the Food Choice Questionnaire developed by Steptoe et al. (Steptoe, A., Pollard, T. M., Wardle, J. (1995). Development of a measure of the motives underlying the selection of food: the food choice questionnaire. Appetite, 25, 267-284) to identify determinants of food choice. Nine factors were identified including mood, which has also been identified in a number of follow-up cross-cultural studies (Eertmans, A., Victoir A., Notelaers, G., Vansant, G., Van den Bergh, O. (2006). The Food Choice Questionnaire: Factorial invariant over western urban populations? Food Quality and Preference, 17, 344-352).

Mood has also been identified as a key behavioral outcome of foods along with cognitive and physical performance (Lieberman H R. Human nutritional neuroscience: fundamental issues. In: Lieberman H R, Kanarek R, Prasad C, eds. Nutritional neuroscience. Boca Raton: CRC Press LLC; 2005:3-10). In fact, mood is often the easiest outcome to measure, more easily measured than physical outcomes or subtle cognitive outcomes. Much of the published food and mood research has come about as part of this tradition of looking for effects of food on human performance (Gibson, E. L. (2006). Emotional influences on food choice: Sensory, physiological and psychological pathways. Physiology & Behavior, 89, 53-61; and Lieberman, 2005).

Despite the evidence that food affects mood, there has been relatively little published on mood research within food product development. This can be attributed to a number of factors including the proprietary interest of companies in aspects of their products which they view as providing a unique competitive edge.

However, another reason is the lack of a standard method or methods for measuring emotions associated with food within the product development context. This context is important because techniques which are appropriate for the academic laboratory research might not be appropriate for commercial settings of consumer laboratories. Academic laboratory research typically uses student volunteers who sometimes participate as part of course requirements. Such studies have minimal time constraints. They also have fewer constraints on the content of the questionnaire materials presented to students or the foods presented to students. There are greater constraints within commercial consumer testing: time is usually constrained, tasks must be reasonable from the consumer perspective, and foods must appear to be viable commercial products.

When one considers measuring mood and emotion, perhaps the first issue which arises is the distinction between mood and emotion. The answer to this question is easier in theory than in practice. In theory one can distinguish at least three different affective behaviors: (1) attitudes which include an evaluative component (e.g. “I like steak.”), (2) emotions, which are brief, intense, and focused on a referent (e.g. “The comment made him angry”), and (3) moods, which are more enduring, build up gradually, are more diffuse, and not focused on a referent (e.g., “I am happy.”).

Thus, there is some agreement on the definitions of mood and emotion, and how to distinguish them in theory. There also is some agreement on general categories of moods and emotions, and lists of moods and emotions. The number of terms to describe specific moods and emotions can be bewildering. Further, much of the research on moods and emotions and many of the resulting questionnaires were developed within a clinical psychiatric setting. The mood and emotion terminology lists reflect this, and can appear negative and sometimes offensive to the average consumer judging a product.

In their recent review, Laros and Steenkamp (Laros, J. M., and Steenkamp, E. M. (2005). Emotions in consumer behavior: a hierarchical approach. Journal of Business Research, 1437-1445) list 173 negative and 143 positive emotions drawn from the literature (Table 2, p. 1439), and further list 39 “basic emotions” also drawn from the literature. The number of terms for basic emotions that are negative far exceeds the number of terms for positive emotions. Laros and Steenkamp caution that their research is based on Dutch data. Rousset et al (2005) report 237 French emotional words, and further, that over 50% of French people surveyed used 70 of the emotional words. Laros and Steenkamp (2005) validated the “wide divergence in the content and structure of emotions used in these studies” and attempted to provide a consumer emotion model. Richins (1997) developed the Emotion questionnaire based on consumer feedback from their product shopping and/or ownership experience. Desmet, P. M. A., & Schifferstein, H. N.J. (2008). Positive and negative emotions associated with food experience. Appetite, 50, 290-301, used 22 emotions, both positive and negative, to describe foods.

At the broadest level, one can view emotions on two dimensions: as positive versus negative (see below in our method), and pleasure/arousal versus displeasure. Laros and Steenkamp catalogue 15 different approaches to such categorizations (Table 1, p. 1438). The most common categorization was positive-negative, and Laros and Steenkamp go on to use this for their basic hierarchy of consumer emotions (Laros and Steenkamp, 2005, FIG. 1, p. 1441). They used 41 terms which were reduced to 33 terms to describe emotional response to foods.

Desmet and Schifferstein (Desmet, P. M. A., Schifferstein, H. N. J. (2008). Sources of positive and negative emotions in food experience. Appetite, 50, 290-301) have measured responses to positive and negative emotion words, which they term pleasant and unpleasant. They noted in two studies that people overwhelmingly use positive rather than negative words, whether describing recalled food experiences or describing reactions to food samples. Desmet and Schifferstein refer to this positive bias as “hedonic asymmetry,” and attribute it to two things: the general “positive affective disposition towards eating and tasting food” and the fact that actual food products “are designed to appeal to consumers.” Gibson (2006) has also commented on the basically positive nature of the food experience. The issue of hedonic asymmetry will be discussed further below.

A number of standardized questionnaires of mood are used in research studies. However, it is important to emphasize that these questionnaires were not designed for general consumer use, and are most often applied in the clinical setting or the research clinical setting, not the food or product laboratory. One of the oldest questionnaires is the Profile of Mood States (POMS) which has its roots in American psychology in the 1940s and 1950s. The Manual for the POMS (McNair, D. M., Lorr, M. Droppleman, L. F. (1971). Profile of mood states. San Diego, Calif.: Educational and Industrial Testing Service) describes the POMS as “a rapid, economical method for identifying and assessing transient, fluctuating affective states” although the authors emphasize the clinical psychiatric goals of the method. The POMS uses 65 mood terms which are rated on a 5 point rating scale. The survey can be oriented towards a variety of time-frames: feelings during the past week, today, right now, and the past three minutes. The POMS measures mood on six dimensions: tension-anxiety, depression-dejection, anger-hostility, vigor-activity, fatigue-inertia, and confusion-bewilderment. The POMS has been used extensively in research and is probably the most widely used questionnaire for research in clinical and academic environments (for example, see Smit, H. J., Rogers T. J. (2002). Effects of ‘energy’ drinks on mood and mental performance: critical methodology. Food Quality and Preference, 13, 317-326; Smith, A. P., Clark, R., Gallagher, J. (1999). Breakfast Cereal and Caffeinated Coffee: Effects on Working Memory, Attention, Mood, and Cardiovascular Function. Physiology & Behavior, 67, 9-17; Lieberman, 2005).

Another mood questionnaire is the Multiple Affect Adjective Check List (MAACL), which is also used extensively in clinical psychiatric settings. The MAACL was first published in 1965 (Zuckerman, M. and Lubin, B. (1965). Manual for the Multiple Affect Adjective Check List. San Diego, Calif.: Educational and Industrial Testing Service), and revised as the MAACL-R in 1985 (Zuckerman, M. and Lubin, B. (1985). The multiple affect adjective check list revised. San Diego, Calif.: Educational and Industrial Testing Service). The authors have also published an extensive bibliography of mood papers (Lubin, Swearingi and Zuckerman, 1997). The MAACL in its revised form (MAACL-R) contains five categories or scales with a total of 66 adjectives. This is a checklist and the terms are not scaled. The questionnaire can be given in a state form (“how you feel now or today”) or a trait form (“how you generally feel”). The MAACL-R has two positive scales, sensation seeking (more active) and positive affect (more passive), and three negative scales, anxiety, depression, and hostility. The authors point out the similarities between the MAACL-R and the POMS, although the correlations between the two scales can vary with instructions (state form v. trait form):

| POMS SCALES | MAACL-R SCALES |
|---|---|
| Tension | Anxiety |
| Depression | Depression |
| Anger | Hostility |
| Fatigue | |
| Confusion | |
| Vigor | Sensation Seeking and Positive Affect |

Another approach to measuring emotions has been the use of facial scaling. A number of different systems for facial scaling have recently appeared including the following: Noldus FaceReader (2007), www.noldus.com (7 basic emotions, 1 positive); Emotionomics (2007), www.sensorylogic.com (7 basic emotions, 1 positive); and PrEmo (2000), www.tustudiolab.nl/desmet.premo (14 basic emotions, 7 positive, 7 negative).

All of these systems have several things in common. They all have a short number of emotions, which are mainly negative emotions; two of the systems have only one positive emotion (happiness), and another has small numbers of both positive and negative emotions. None of these facial scaling systems was designed especially for consumer products such as food. Accordingly, a richer, more detailed emotional profile is needed.

### SUMMARY

A method of measuring consumer emotions associated with a targeted food product comprises producing a list of emotional terms, validating emotional terms from the list that consumers use with food products, developing a questionnaire, using the validated emotional terms, that asks the consumers to describe their feelings associated with the targeted food product, and analyzing data from the completed questionnaire.

The questionnaire includes a plurality of validated emotional terms associated with the product and a scale next to each of the emotional terms for the consumer to indicate the applicability of the validated emotional terms associated with the product.

### BRIEF DESCRIPTION OF THE DRAWINGS

The exemplary embodiments will be better understood from reading the description which follows and from examining the accompanying figures. These are provided solely as non-limiting examples of the embodiments. In the drawings:

FIG. 1 is a table of exemplary consumer classifications of emotions;

FIG. 2 is an exemplary questionnaire;

FIG. 3 is an exemplary emotion profile;

FIG. 4 is an exemplary ballot of overall acceptability and emotion ratings;

FIG. 5 is a chart showing exemplary statistically significant differences among products;

FIG. 6 is a graph showing exemplary statistically significant differences among products;

FIG. 7 is a chart showing exemplary gender effect on emotions for different flavors;

FIG. 8 is a chart showing exemplary effects of product usage on emotion response;

FIGS. 9A-9H are an exemplary computerized ballot for a central location test;

FIG. 10 is a table of exemplary interpretations of emotions by gender;

FIG. 11 is a table of additional exemplary interpretations of emotions by gender;

FIG. 12 is a table of exemplary interpretations of emotions according to psychographics;

FIG. 13 is a table of additional exemplary interpretations of emotions according to psychographics;

FIG. 14 is a table of exemplary scores for attributes differentiating products;

FIG. 15 is table showing exemplary emotions associated with chicken products;

FIG. 16 is another exemplary emotion profile; and

FIG. 17 is a chart showing exemplary emotions associated with food preparation.

### DETAILED DESCRIPTION

Reference will now be made in detail to the exemplary embodiments illustrated in the accompanying drawings. Wherever possible, the same reference characters will be used throughout the drawings to refer to the same or like parts.

A method to measure consumer emotions associated with products, such as food, includes the development of a questionnaire to measure emotion and mood in a commercial context. The development aims to identify appropriate terms to measure emotions associated with foods maximizing information about the product, identify scaling approaches to measure emotions with consumers, develop a test protocol to evaluate food and measure emotions, and identify method applications.

In an exemplary embodiment of such a questionnaire, the list of emotions to be validated and included in the questionnaire evolved from two sources: existing mood and emotion questionnaires and new terms generated by consumer research. These existing questionnaires included the MAACL-R (Zuckerman and Lubin, 1985) and the POMS (McNair et al, 1971). New terms were collected from thousands of consumers via the internet, central location tests (CLT) and a focus group. A total of 81 collective terms were evaluated. The terms were evaluated individually and/or clustered in groups of two or three terms based on the similarity of their definition (the Microsoft Thesaurus was used to identify groupings).

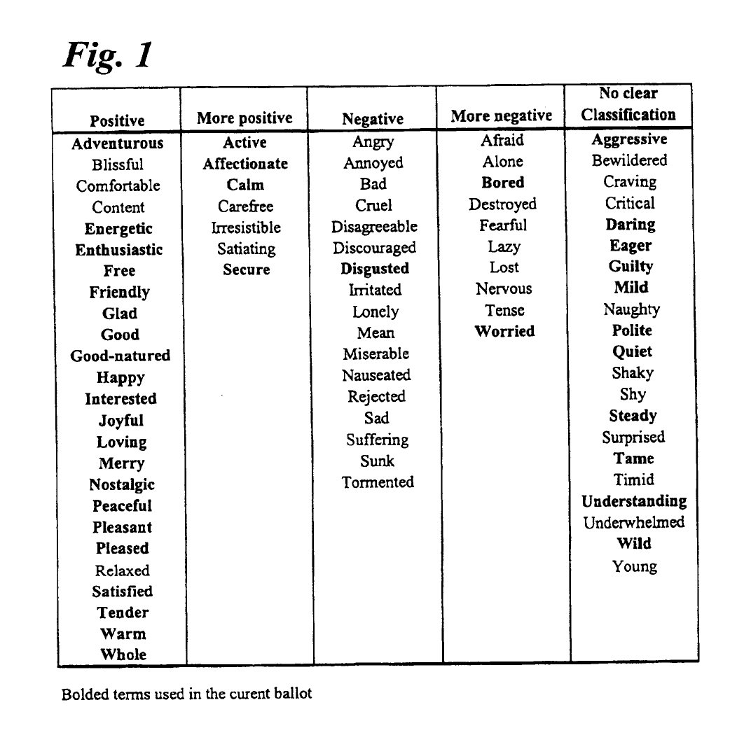

A nationwide internet survey was used to identify emotion attributes U.S. consumers use to describe a variety of foods. Respondents (n=105) were asked to describe their favorite beverage, snack, or dessert as well as their least favorite meal, dessert, and snack. Next, they were presented with a list of emotions based on the previous sources as well as some initial consumer feedback and asked to describe how they felt when consuming each product by selecting one or more words that described their feelings. FIG. 1 presents a list of terms of consumer classification of emotions. Consumers categorized emotions associated with food into positive, negative, both positive and negative, and neither positive nor negative. The emotions were then grouped into three distinct categories: positive, negative, or unclear.

Positive emotion terms were used to describe favorite foods while negative terms were associated with least favorite foods. Positive terms were used with higher frequency; 20% of the time or more four negative terms were selected (bored, disgusted, annoyed, and disagreeable), as compared with 10 positive terms (pleased, good, satisfied, calm, friendly, active, peaceful, enthusiastic, free, affectionate). It has been confirmed that consumers use positive emotions to describe human reactions to foods they like.

In an effort to understand consumers' use of these emotion terms, an internet study was conducted in which 200 respondents were asked to categorize emotion terms, as they relate to food, as positive, negative, both positive and negative, or neither positive nor negative. The objective of this study was to identify those terms that are more clearly understood by most consumers as compared with those terms that are unclear or may have different interpretations depending on the individual and/or situation. Terms selected less than 60% were categorized as positive or negative. In addition, there were terms that were less clearly positive or negative (50-59% frequency). Terms selected less than 50% of the time as positive or negative were grouped as inconclusive. The results are shown in FIG. 1.

Of the 80 terms evaluated, 32 were positive (25 clearly positive and 7 not as clearly positive) and 27 were negative (17 clearly negative and 10 not as clearly negative), leaving 21 terms with no clear classification. These results show that people vary in their perception of emotional terms as positive or negative, making the task more challenging. Factors that may result in this disagreement could include consumer demographic and/or psychographic differences as well as the food and/or context in which the food may be consumed.

The negative terms selected from this test for use in the final questionnaire were ‘disgusted’, ‘guilty’ and ‘bored’; and also ‘aggressive’, ‘mild’, ‘quiet’, ‘tame’, ‘daring’ and ‘wild’ from the “unclear” classification, as these were more frequently used by consumers. Some of the terms classified as “unclear” were selected based on consumer use for specific product categories/profiles (aggressive, mild, daring, wild); the other terms are part of the sensation seeking classification for the MACCL-R questionnaire which were found to be applicable given some of the current food trends.

The goal for questionnaire length was not to exceed 10-15 minutes to complete an internet survey, and less than 30 minutes for a consumer test. Terms were selected based on frequency of use, term categorization, and consumer feedback regarding their appropriateness to food. Specifically, consumers were asked to read a list of emotions and, using a choose all that apply scaling, check only those emotions they felt in association with a food terms. Terms selected by consumers at least 20% of the time were included in the list of validated terms.

As testing progressed, respondents were given an opportunity to comment on the test approach. Comments associated with the test format suggested that the approach was different and fun. Less than 1% of consumers found the test approach and questions unusual. One or two respondents in each test (n of 100 or more) found some of the terms offensive, specifically when the original questionnaire included terms associated with depression and anxiety, and questioned the objective of the test.

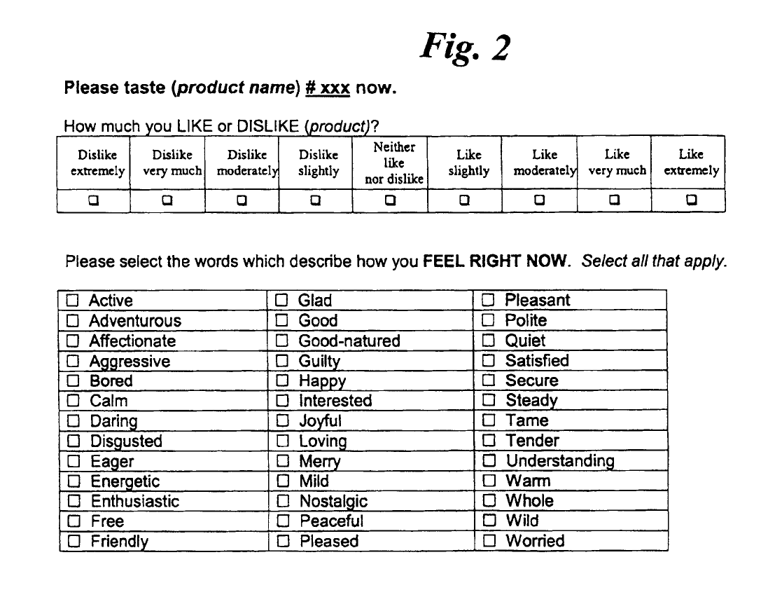

This small percentage of questioning responses needs to be minimized in the commercial setting. Thus, many negative terms such as those terms associated with depression, hostility, and anxiety were excluded from the questionnaire. A few negative or non-classifiable terms (calm, guilty, and nostalgic) were included in the questionnaire based on specific consumer feedback. The current list of validated emotional terms used on a standard questionnaire is shown in FIG. 2 and discussed below.

In initial testing, consumers chose the terms to describe their feelings about a targeted product in the hope that this fast check-all-that-apply method would produce meaningful results in the commercial testing context. FIG. 2 shows an exemplary consumer questionnaire developed with terms from the list shown in bold in FIG. 1.

The terms in FIG. 2 represent the standard 39 validated emotional terms. This list may be used as a starting point for evaluating new product applications or may be partially varied to accommodate a particular product application. As discussed below, some of these terms may not be appropriate for all product applications. Thus, alternative terms can be substituted for some of these 39 terms. However, at least two-thirds (26 terms) of the terms listed in FIG. 2 should be used. More preferably, at least 30, and even more preferably, at least 35 of these terms should be used. Further, even when additional terms are added, no more than 45 total terms, and preferably no more than 40 terms should be used. At least 33 total terms should be used. In cases where additional terms are included, the newly added terms should still be validated as appropriate for the particular food product application at issue.

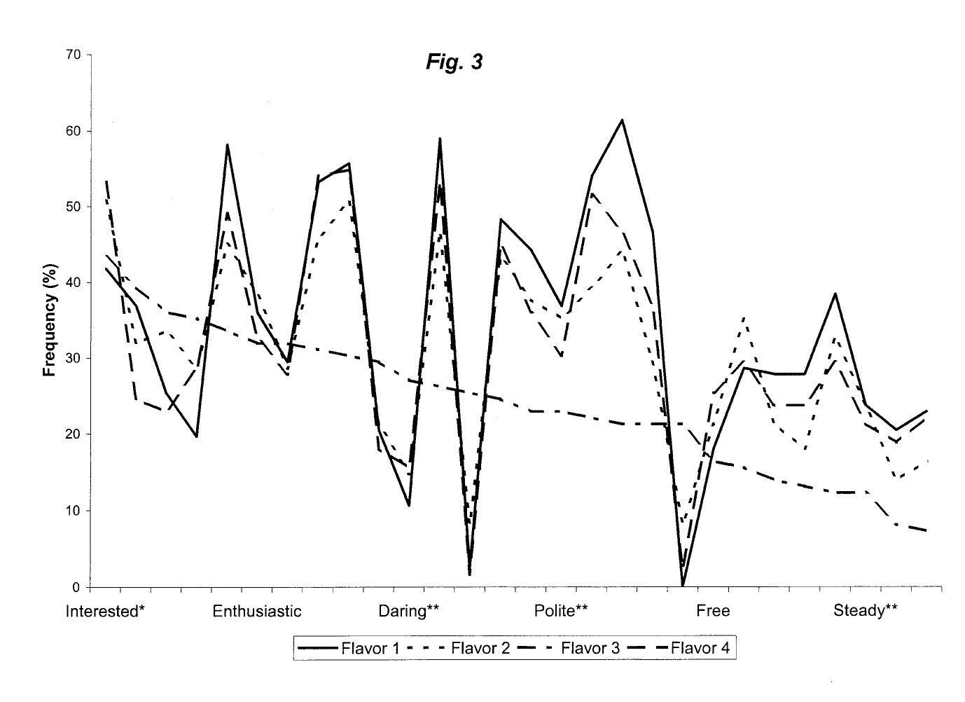

The checklist approach from the questionnaire shown in FIG. 2 was useful for differentiating different products such as flavored crackers with different flavor profiles. FIG. 3 shows the results of a study performed at a CLT using a questionnaire similar to that of FIG. 2 for four products in the same food category (flavored crackers).

In this case, four targeted products could be differentiated based on their emotion profile. One of the products, Flavor 3, was clearly different and many of the emotions were less frequently selected compared to the other products. Experiments were then conducted with a rating scale approach for emotions, in the hope that scaling emotions would provide additional information which would be useful in product development decisions.

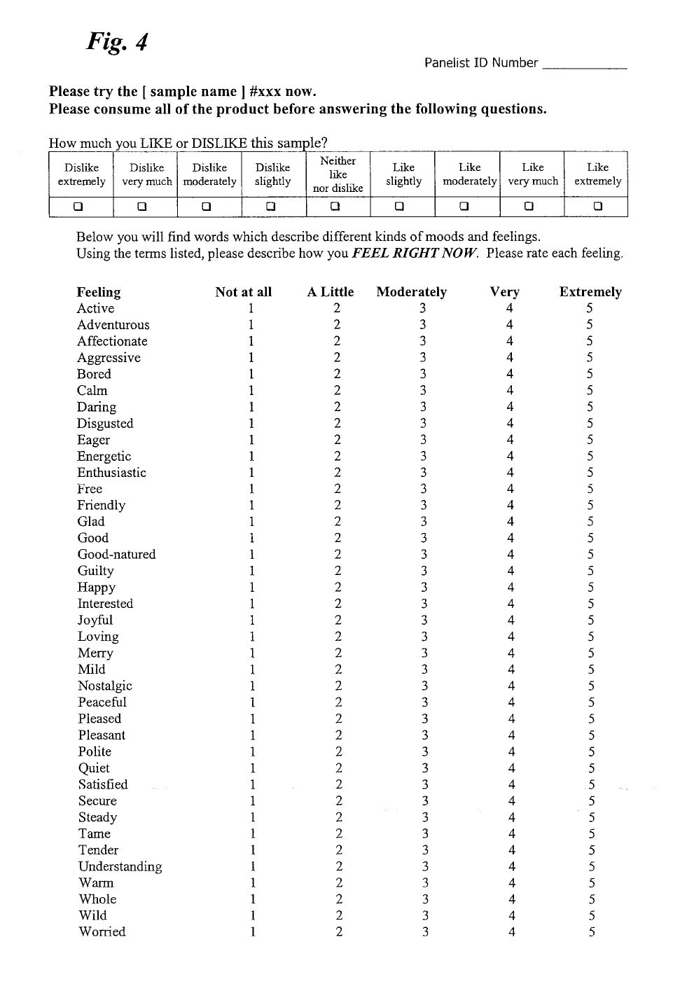

The next step was to measure emotion intensities using a 5-point intensity scale from 1=not at all to 5=extremely. FIG. 4 shows a consumer questionnaire of overall acceptability and emotion ratings according to the 5-point scale. This questionnaire was designed to differentiate among products as well as within product variations and has been named the EsSense Profile™. In addition, a 9-point hedonic scale was incorporated into the ballot to evaluate overall acceptability of the product and provide an anchor to current consumer testing methods. This hedonic scale was added to both the checklist and the rating ballot. Thus, the questionnaire can be used to compare a targeted food product to one or more additional food products. The additional food products can also be targeted food products or can be known products used to form a baseline.

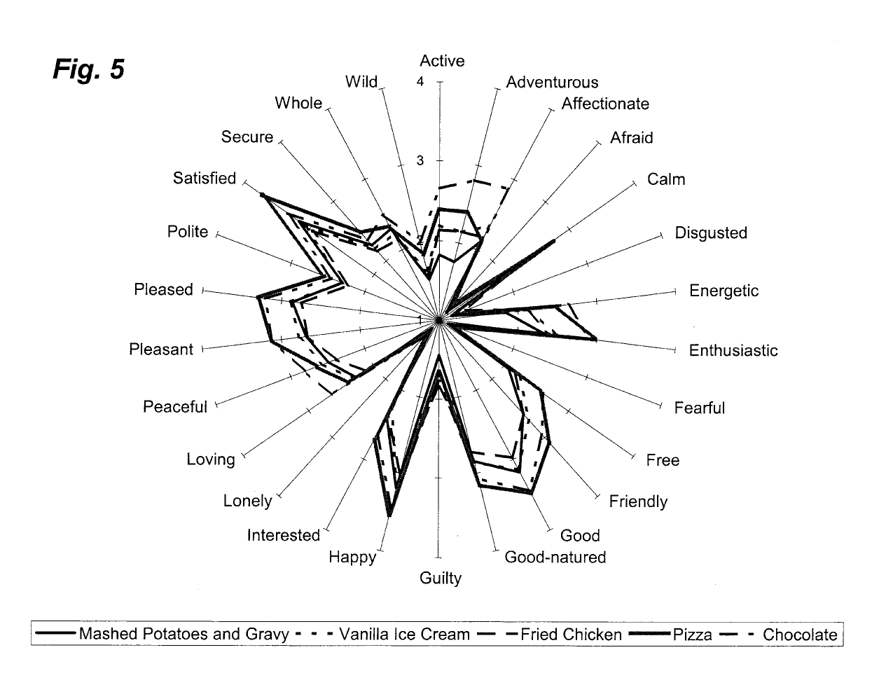

In one exemplary embodiment, this test approach was used in an internet survey with 149 participants to differentiate different product categories such as pizza, chocolate, vanilla ice cream, fried chicken, and mashed potatoes and gravy. FIG. 5 is a radar chart that shows those attributes that resulted in a statistically significant difference among products (p≦0.05). In this chart, a rating of 1 is equal to a response of not at all and a rating of 5 is equal to extremely.

By plotting the results on the chart shown in FIG. 5, it can be seen that pizza and chocolate produced the strongest emotions. The terms active, adventurous, affectionate, whole, and loving were highest in intensity for chocolate. Pizza was highest in satisfied, both pizza and chocolate for energetic, enthusiastic, free, friendly, good, good natured, interested, pleased, and pleasant. Mashed potatoes was lowest for guilty, while chocolate, pizza, and fried chicken were highest for guilty. The results of this test demonstrated that the rating ballot was useful in differentiating a variety of food products.

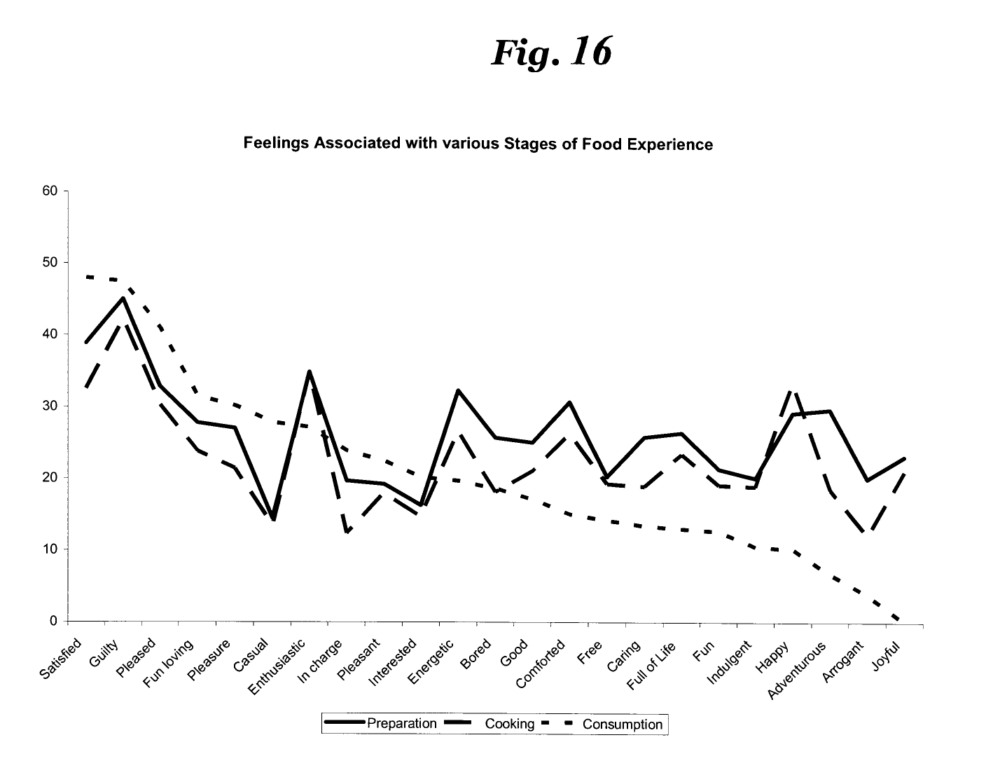

FIG. 16 shows the results of another study testing emotions associated with preparation of a targeted food. The study tested and validated the emotion questionnaire to be used for this targeted product by having consumers check which emotions they feel at different stages of the food experience. The frequency with which certain emotional terms were selected by the consumers is shown in FIG. 16.

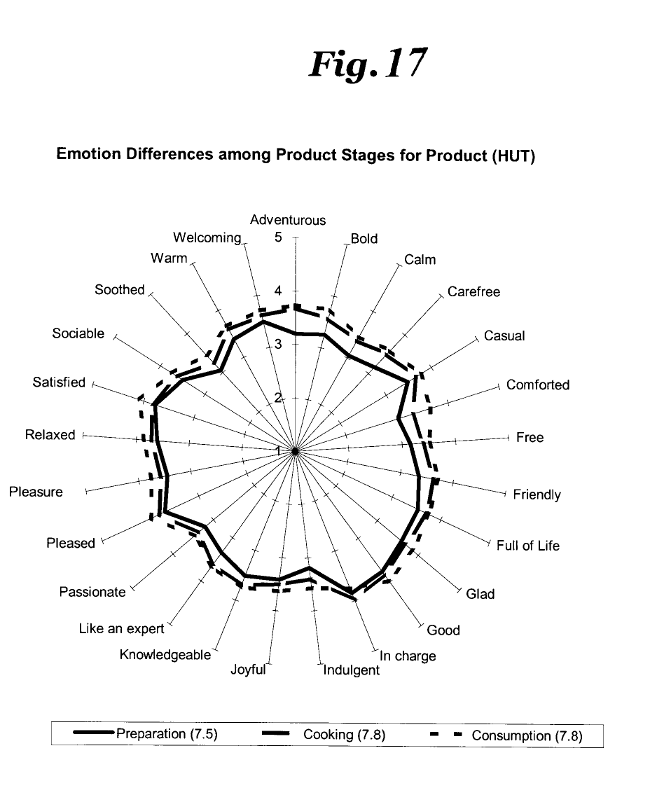

Another test measured the results of a home use test where consumers actually prepared, cooked, and consumed the targeted foods. The five-point intensity scale was used to create the radar chart showing the results in FIG. 17.

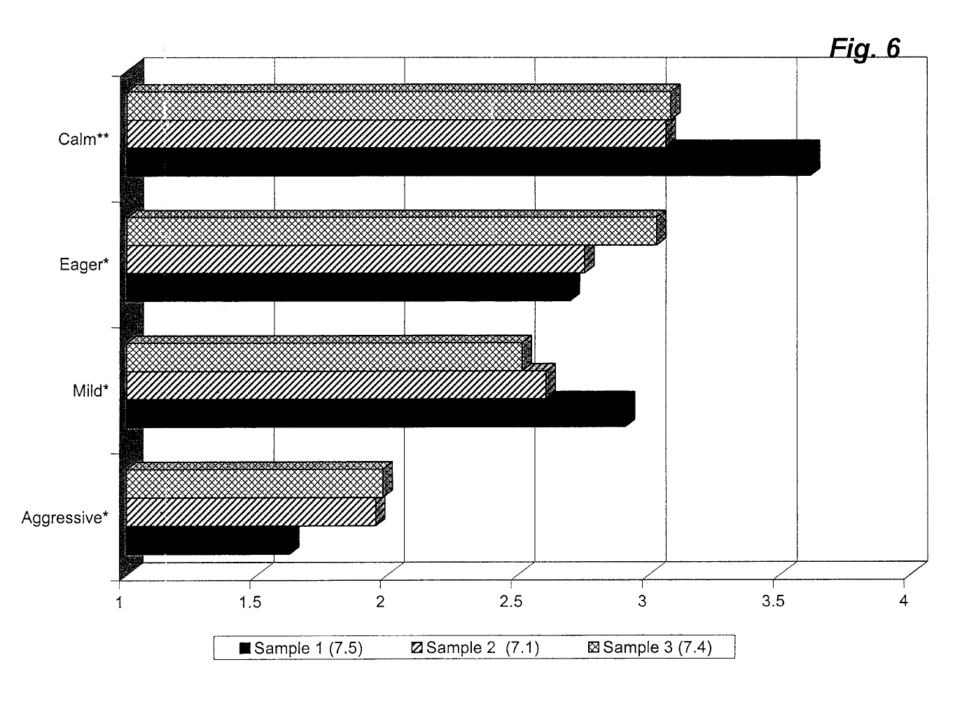

This method was also tested with variations within the same product. FIG. 6 shows the results from a test in which salty snack crackers were the targeted product. In this CLT (n=109) the control resulted in higher calm and mild emotions, while both test samples were rated higher in aggressive and test sample 2 rated higher in eager. The results of this test concluded that a rating ballot was useful in differentiating flavor variations of the same product. Test results, such as these, provide useful and actionable data by indicating if any emotions differentiate the test products, and if so, which emotions are stronger or weaker for each particular sample. These data can then be compared to the brand essence or positioning as well as consumer expectations from the product and/or brand and determine if and which sample best represents the brand.

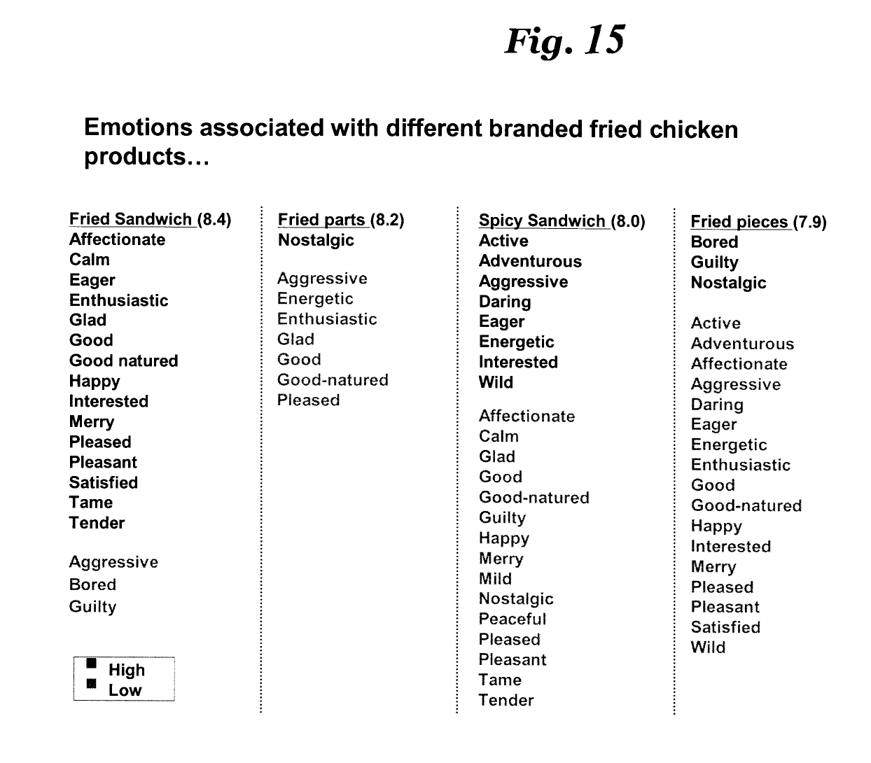

FIG. 15 shows another exemplary embodiment where the emotions associated with various chicken products are tested by the questionnaire. The overall acceptability score and the emotional terms associated with each of a fried chicken sandwich, fried chicken parts, a spicy chicken sandwich, and fried chicken pieces is shown. With a score of 8.4, the fried chicken sandwich has the highest overall acceptability. However, the list of emotional terms can be used to guide product development decisions. For example, if a new product that makes the consumer feel nostalgic and not guilty is desired, an analysis of the results shown in FIG. 15 may lead the producer to select the fried chicken parts over the fried chicken sandwich.

The emotional terms are presented in alphabetical order, as shown in FIG. 4, so consumers can get acquainted with the ballot more quickly and shorten the task over each sample evaluation. When compared with a randomized attribute presentation, the results were similar for this alphabetized approach (correlation coefficient=0.99), with perhaps a slight increase in emotion intensity when attributes are presented in random order. This suggests that the order does not impact the results, and allows for a simpler task for the respondent. When applying this questionnaire in different contexts than used above, any effect of the order should be checked.

Data can be collected via internet survey, CLT, and home use tests. In an exemplary embodiment involving CLTs, CLTs were conducted in the typical format as has been reported in previous publications (King, S. C., Weber A. J., Meiselman H. L., Lv N. (2004). The effect of meal situation, social interaction, physical environment and choice on food acceptability. Food Quality and Preference, 15, 645-654; King, S. C., Meiselman, H. L., Hottenstein, A. W., Work, T. M. and Cronk, V. (2007). ‘The effect of contextual variables on food acceptability: A confirmatory study’. Food Quality and Preference, 18, 58-65; King, S. C., Meiselman, H. L., Henriques, A. (2008). The effect of choice and psychographics on the acceptability of novel flavors. Food Quality and Preference, 19, 692-696; Henriques, A. S., King, S. C., Meiselman, H. L. (2009). Consumer segmentation based on food neophobia and its application to product development. Food Quality and Preference, 20, 83-91). Specifically, consumers are screened and recruited via internet and/or phone, based on being a user of a specific product or product category. Consumers report to the central test location for an assigned appointment. Testing commonly lasts from 15 to 30 minutes. Consumers can be compensated for their participation. Consumers for these emotion tests included product users for the product under test, of both genders and between the ages 18 to 65 years.

Samples for one CLT were commercial products as well as products under development. Typically, a small portion of a product was presented to consumers; for cracker products this was typically two or three crackers or one biscuit depending on the size of the product. The data were collected using a computer system (Compusense, for example) to collect responses to overall acceptability and EsSense Profile™ emotions. Instructions for tasting and rinsing are provided both verbally and via computer. The program uses a timer to provided measured breaks between samples ranging from two and a half to five minutes. Simplified examples of the ballot are presented in FIGS. 2 and 4.

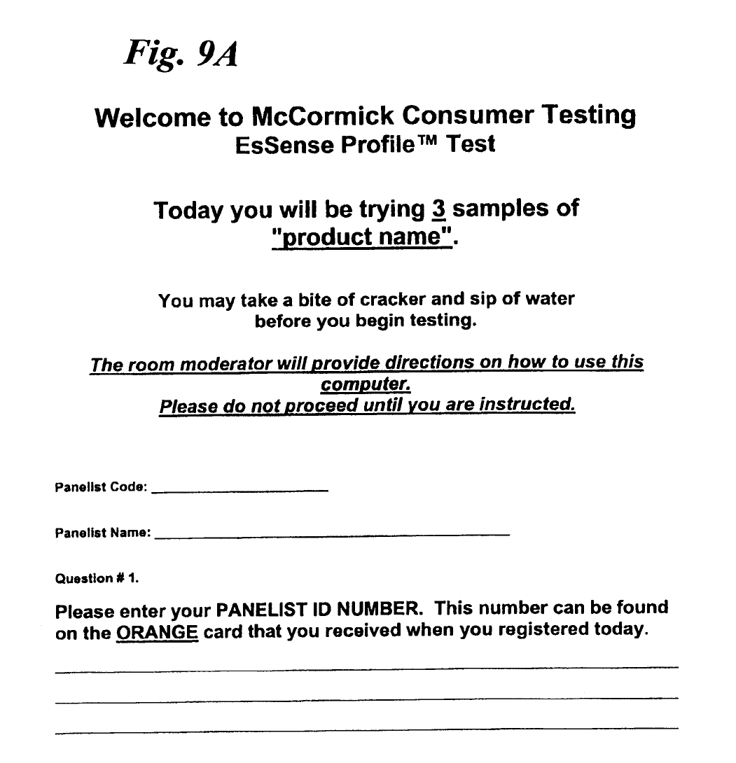

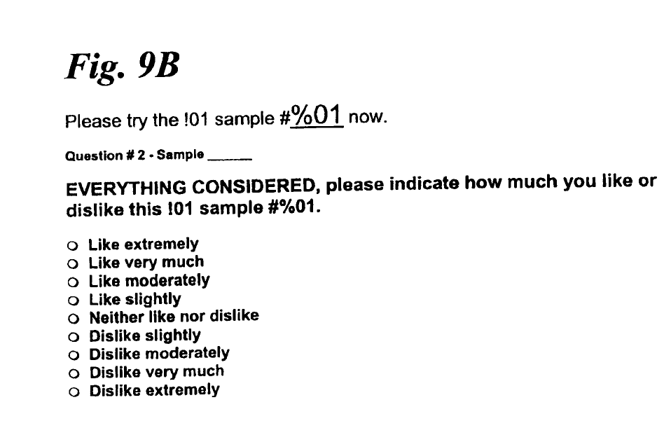

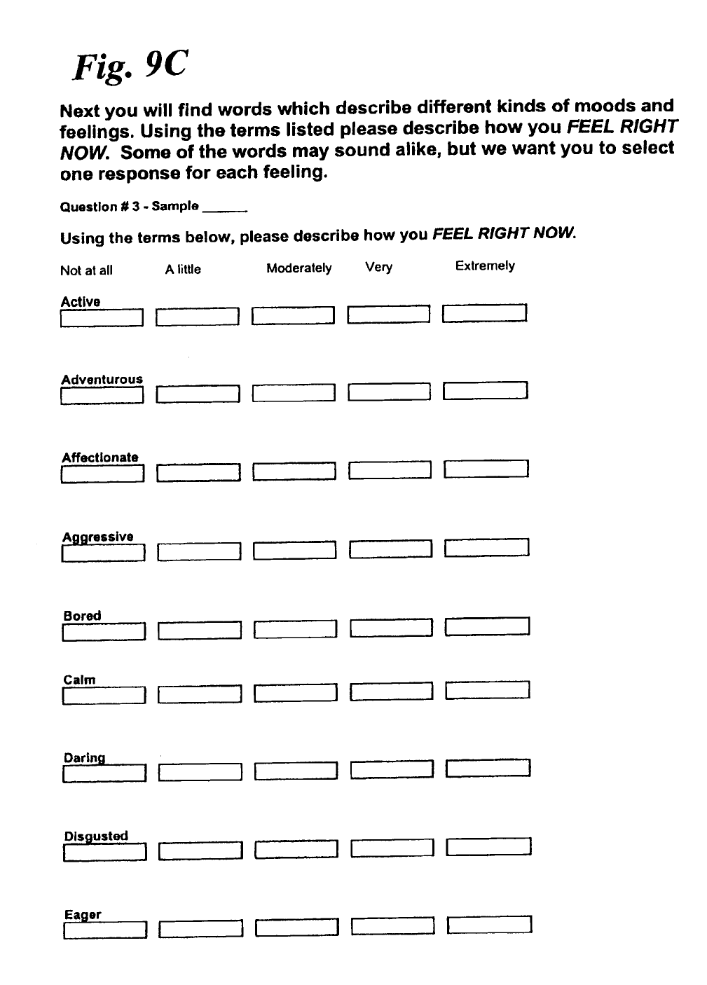

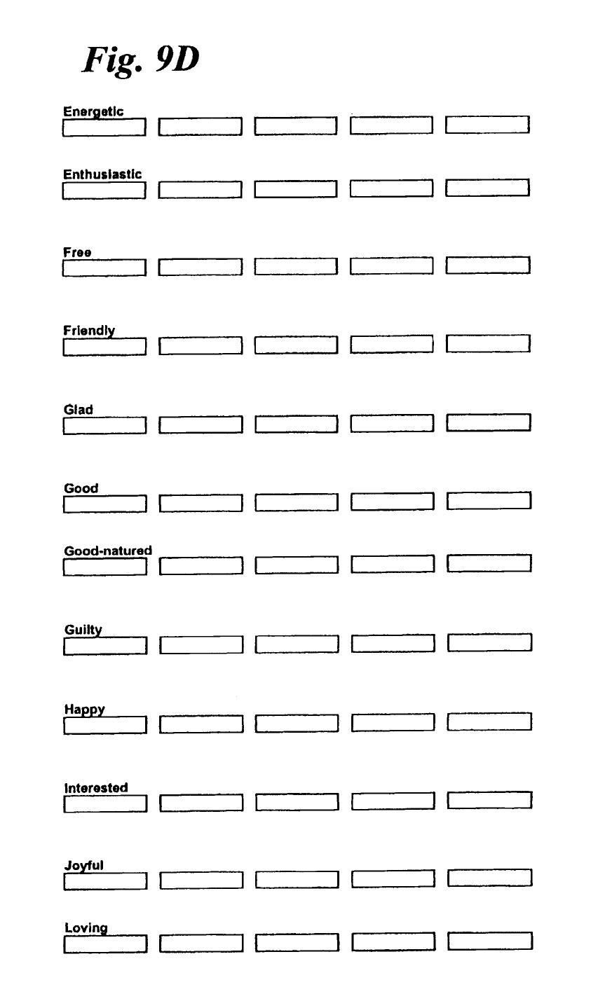

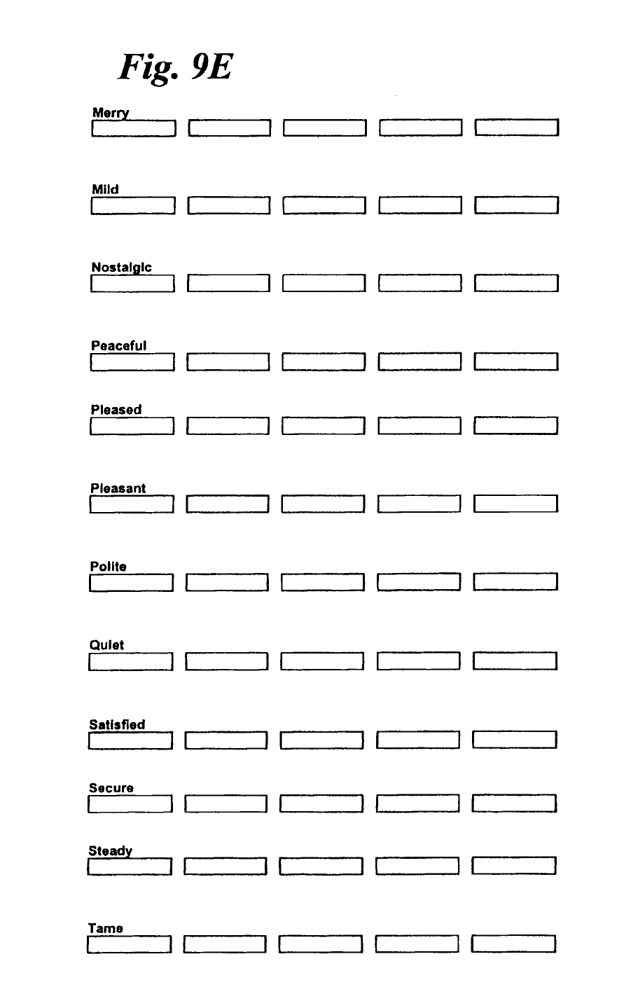

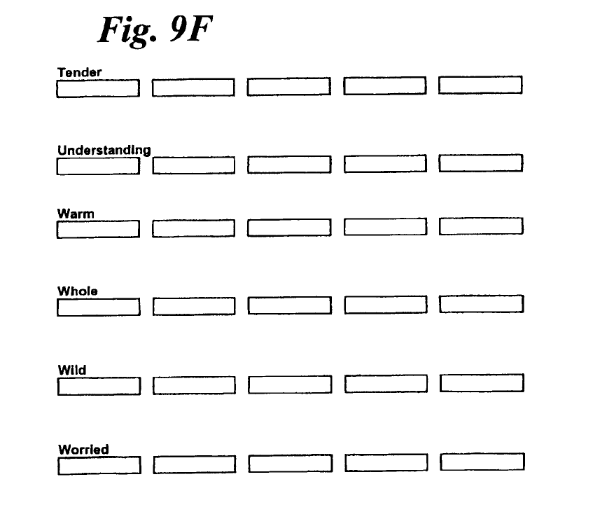

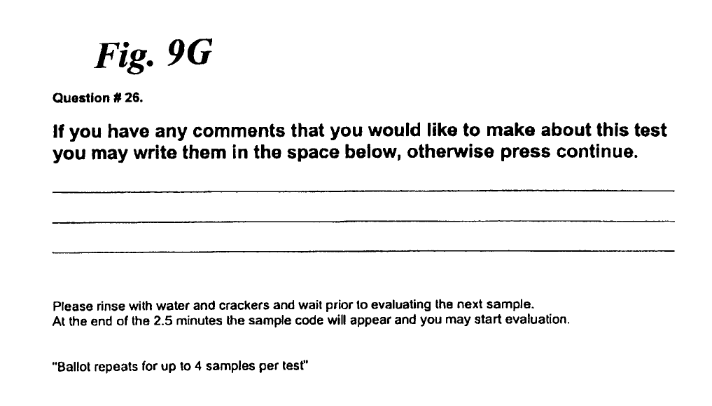

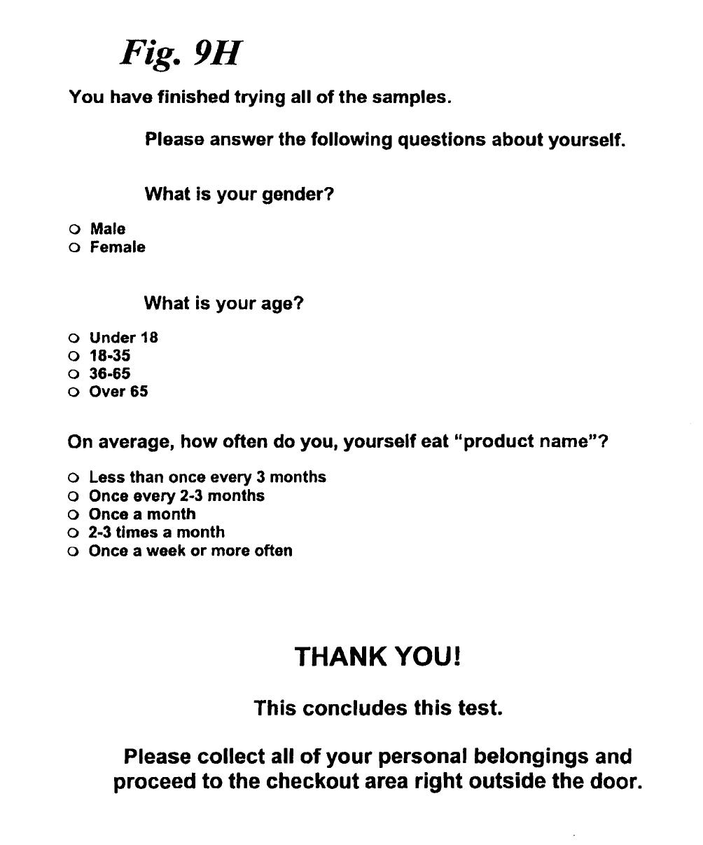

An example of a standard computer ballot is presented in FIGS. 9A-9H. The computerized ballot provides flexibility about the attribute presentation. therefore, the overall acceptability question can be asked first, then the emotion attributes are presented on a separate page. Once they score each page, participants are not allowed to return to previous pages to make changes, keeping the data intact and based solely on first impression.

Since emotion is an immediate response to a referent, the overall acceptability and emotions were measured while consuming each sample or immediately after consuming a portion of the sample. A two to three minute break between samples is enforced, as well as palate rinsing with filtered water, and unsalted crackers. The amount of time required to evaluate each sample averaged between two and four minutes.

In one exemplary embodiment of internet studies, people were contacted via the internet from a consumer database. Approximately 1000 or more U.S. consumers were contacted per study. Each survey lasted 10-15 minutes. A select number of participants can be compensated based on their interest in winning a prize by providing their email address for random prize selection. These studies demonstrated that emotional responses can be collected for product names based on memory-emotional associations with the product. These tests have been used to develop baseline emotional profiles for products and identify predominant emotions for that product; it has also been used to map brands of a specific product (i.e.: BBQ sauce) and identify the emotions associated with the product in general as well as the different emotions that describe each brand. The maps are created using statistical tools, such as principal component analysis (PCA) to plot the emotions and products based on data patterns. This information is used to identify key emotional characteristics to target in product development and/or identify areas of opportunity in the market.

The questionnaire can measure the emotions that the consumers associate with a targeted food product. Further, emotions associated with consumption of the food product or with the name or concept of the food product can be measured. The questionnaire can also measure emotions associated with the brand name or packaging of the food product. Further, emotions associated with food preparation or anticipation of eating the food product can be measured. Thus, the questionnaire can be used to measure emotions associated with a wide range of areas regarding the targeted food product.

Results of sixteen CLT studies across products (n=5159) indicate that male and females rate the emotions associated with foods similarly, with some exceptions. Males score two emotions, aggressive and wild, higher than females (0.4 and 0.3 unit difference respectively, p<0.01). Gender differences were observed for some products and not for others.

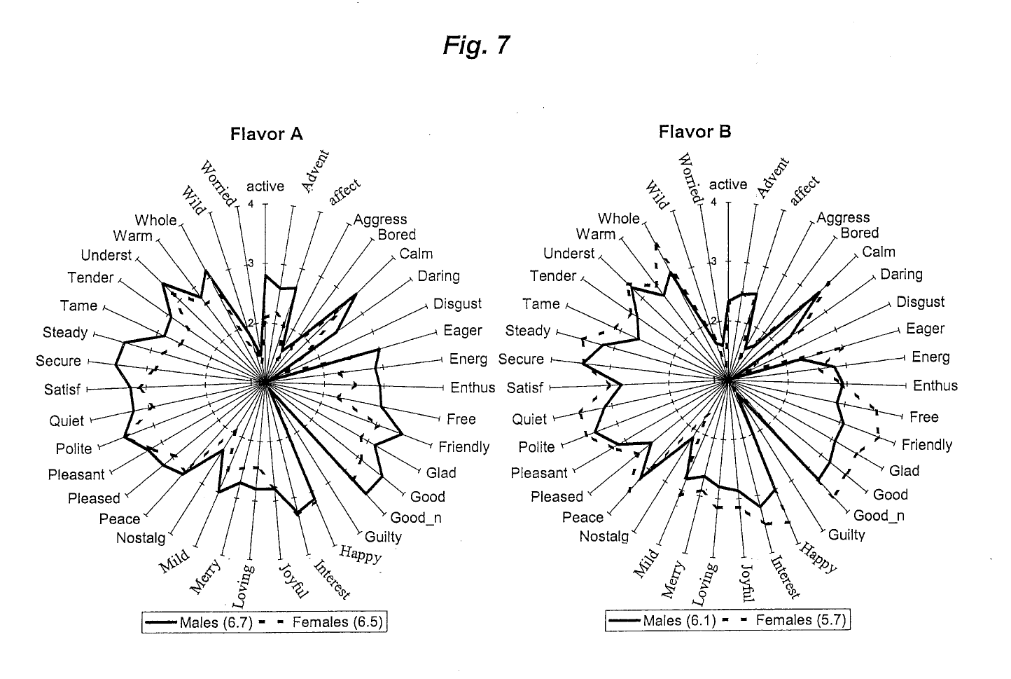

FIG. 7 demonstrates how one gender may have an emotional affinity for specific flavors and/or products. Flavor A and Flavor B are two different flavors applied to bread biscuit prototypes. The male emotion profile for Flavor A was stronger/more intense than for females. On the other hand, females showed stronger emotion intensities than males for Flavor B. This may suggest gender specificity for food products. These differences can be observed between product categories but more importantly within product formulations. In some cases, these differences relate to differences in overall acceptability between genders, but as seen in this example, overall acceptability differences (scores in parenthesis next to the legend) were relatively small for Flavor A, while emotion intensity differences were large.

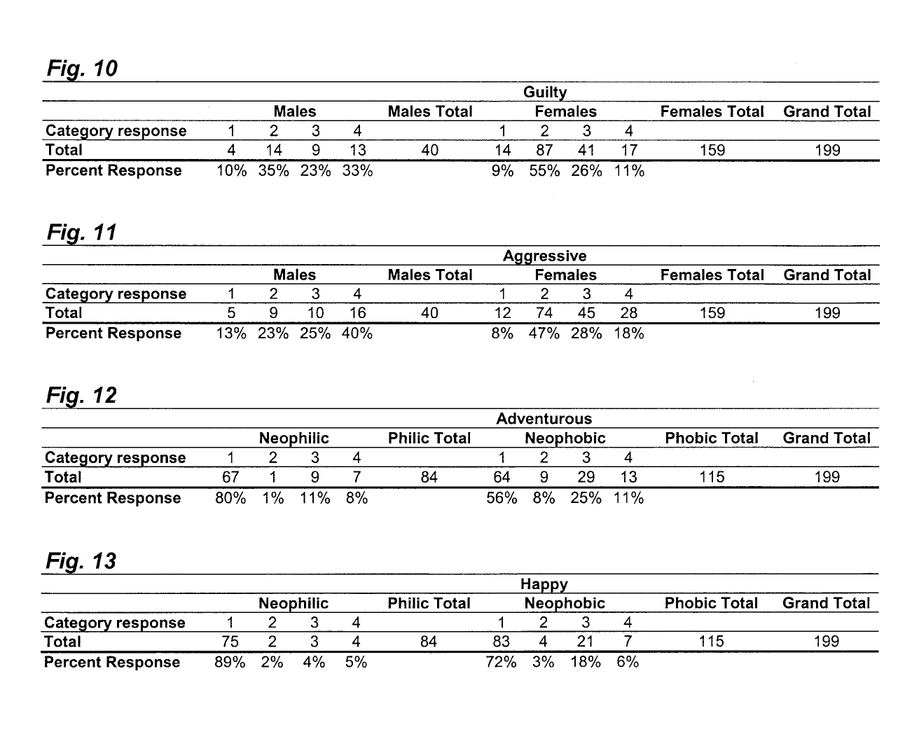

Gender also has an impact on how emotions are interpreted. When comparing male and female response to emotions, the present inventors discovered that the terms are not always categorized the same way. For example, as shown in FIG. 10, the term guilty is more strongly classified as a negative term by females (55%) versus males (35%). In addition, more males rated the term guilty as “neither positive nor negative” (33%) vs. females (11%).

Another example is the term “aggressive.” As shown in FIG. 11, males (55%) classify this emotion as neither positive nor negative, while females split their decision equally among three of the classifications: 36% negative, 33% both positive and negative, 33% neither positive nor negative. Once again, gender perceptions/definitions vary suggesting that when consumers evaluate products, their use of the emotions may vary based on gender and their definition of whether the emotion elicits a positive or a negative feeling, both, or neither. Demographic categories, such as gender, are commonly used to screen participants in a consumer test because some products may have more appeal to or may target males or females. Emotion responses from a consumer test are evaluated as a group overall, but may also be evaluated within a gender group. These data provide additional insights on how males and/or females respond to the product and whether their responses are consistent between groups, or whether one gender has stronger positive and/or negative emotional response to the product.

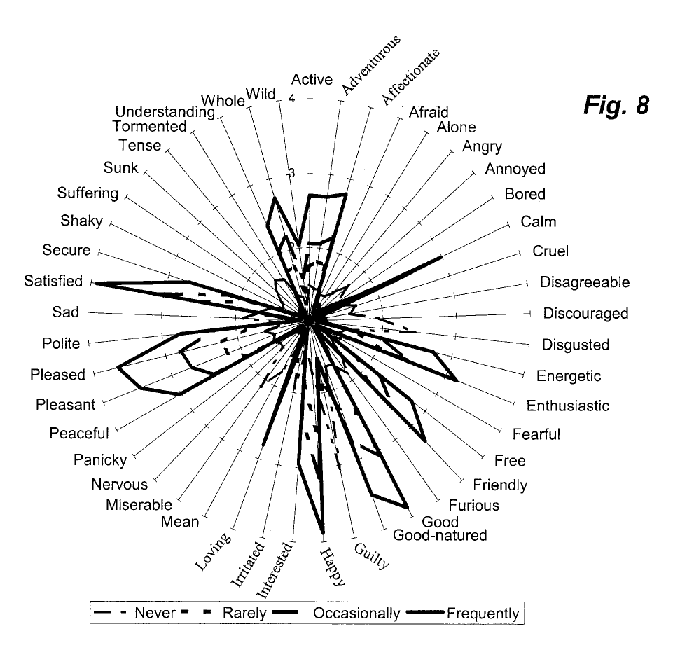

Emotion intensities increase as the frequency of product use increases, as shown in FIG. 8. Specifically, FIG. 8 shows consumer profiles averaged over five different products. Non-product users have a different emotion profile which is altogether focused on negative emotions, while product users in general have stronger positive emotions.

Psychographics, such as food neophobia, impact the use of emotion terms. Food neophobia is defined as the reluctance to try new or novel foods, and neophilics are described as having lower or no neophobic tendencies. Neophobia has an impact on how the emotion terms are defined and used. Typically, neophobics rate the intensity of emotions lower than neophilics. When categorizing emotions into negative and positive terms, there are many discrepancies which reflect a more cautious attitude by neophobics. For example, as shown in FIG. 12, while 80% of neophilics categorize adventurous as a positive emotion, only 56% neophobics do; 25% of neophobics rate adventurous as both positive and negative.

Another example is the term “happy.” As shown in FIG. 13, 72% of neophilics classify this term as positive as it relates to food, while only 46% of neophobics do. Neophobics (35%) consider the term happy as both a positive and a negative emotion.

Data collected from these types of tests (internet survey, CLT, and home use tests) are evaluated using means and standard deviation to determine average emotion scores and amount of variability in the responses.

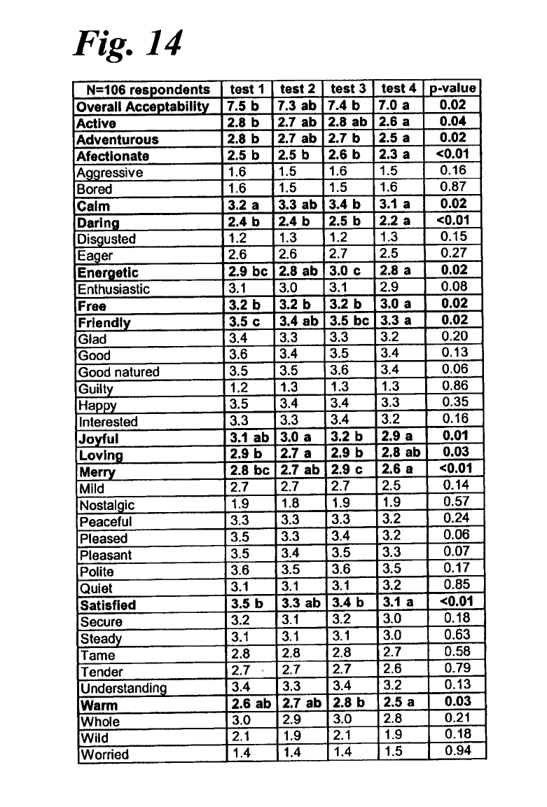

Analysis of variance is used to determine if different samples/product means differ significantly for each emotion attribute. If a significant difference is found, then a mean separation procedure, such as LSD (least significant difference) is used to determine which samples are different from each other. For example, the table shown in FIG. 14 includes mean scores for attributes differentiating four products. A probability of ≦0.05 indicates a significant difference among the samples for the particular attribute/emotion, while the letters next to each of the mean scores, within an attribute, indicate which samples are similar or different from each other; for example, for the term affectionate, the mean score for Test 4 is significantly different and lower than the other 3 test samples.

Test 4 in FIG. 14 rated lower in overall acceptability, active, adventurous, affectionate, daring, free, friendly, joyful, merry, satisfied, and warm. Since the objective for this study was to identify test samples that are high in overall acceptability while eliciting high adventurous and satisfying emotions, Test 4 would not be selected for further development, while Tests 1, 2, and 3 rated higher for these emotions. In addition, Test 1 may have an advantage over the other samples given the higher acceptability, adventure, and satisfied scores.

The steps in developing a method to measure emotions in a commercial setting include identifying emotion terms, choosing a scaling system, and applying the questionnaire to products in a commercial setting, to demonstrate the ability of the questionnaire to describe products and to discriminate among products. By analyzing the data from the questionnaire, we are able to make different decisions depending on the objective: 1) profile the market for a specific product—emotions can help identify the overall emotional profile for the product as well as identify how different flavors may elicit or not similar emotions, or how different brands may elicit different emotions of the same product; 2) product reformulations—we can use emotions as well as acceptability to demonstrate that an ingredient substitution or product reformulation does not change the acceptability and or emotional profile of the product, therefore delivering a consistent emotional experience for the consumer.

The development of a new questionnaire to measure consumer emotions in a product development context has produced an instrument which gives new information which is not normally captured by measuring acceptability. The results are in line with a number of authors who have argued that measurement of acceptability is not a sufficient benchmark for product development and testing. Koster and Mojet (Koster, E. P. and Mojet, J. (2008). Boredom and the reasons some new products fail. In MacFie, H. (Ed.) Consumer-led Product Development. Cambridge, England: Woodhead Publishing Ltd., pp. 262-280) have argued that we need to move beyond acceptance testing and move beyond acceptance testing within a central location test environment. The present instrument to measure mood and emotion works within the laboratory (CLT), but also over the internet and in the home through either printed or online testing. Thomson (Thomson, D. (2008). SensoEmotional optimisation of food products and brands. In MacFie, H. (Ed.) Consumer-led Product Development. Cambridge, England: Woodhead Publishing Ltd., pp. 281-306) has also argued that concepts such as satisfaction are more appropriate than simple acceptance for commercial products, and that both brand and packaging need to be considered along with the product. As a result of their research, the present inventors have found that the combination of emotions and acceptability taps into some of the same dimensions which produce satisfaction.

While the measurement of mood and emotions gives new information beyond acceptance, it is nevertheless interesting to relate emotions and acceptance. The data collected to date suggest that emotional intensity does not always track with acceptance. For example, FIG. 6 shows an example of highly acceptable products with different emotional intensities. For the products tested in FIG. 6, it is clear that the overall acceptance does not track with the emotion response pattern. Thus, this method might help to explain acceptance data and why acceptance data does not always predict market success.

To find a questionnaire useful in the commercial context, standardized mood and emotion questionnaires from the clinical/psychiatric environment were examined. The emotion terms from these standard questionnaires were tested on the internet and in person with consumers. A number of things were observed. The vast majority of self reports about foods are positive. This observation is in agreement with Gibson (2006) and Desmet and Schifferstein (2008) both of whom underscored that eating is basically a positive experience for healthy people. Thus, it was determined that standardized questionnaires are a good source of emotions for developing a questionnaire. However, the standardized questionnaire terms had to be supplemented with additional terms collected from consumers thinking about or experiencing food. In addition, a number of terms from the standardized questionnaires were eliminated because they were not appropriate for foods; consumers did not use them when describing their emotional reactions to foods.

The list of terms shown in the finalized consumer ballot of FIG. 2 is not a final list of emotion terms to be used with any food, or even more, with any consumer product. One comprehensive list of emotions will likely not cover all food categories. Instead, different classes of foods will likely require different sets of terms. Researchers investigating a large range of beverages, or a large range of (simple and complex) main dishes might need to both reduce and add to this list of terms. However, this list is a good place to start for those who wish to study the impact of foods on emotions.

Clearly, a large number of emotions terms are needed to fully characterize the emotional response to foods. In research conducted by the present inventors, as many as 36 out of 39 terms were observed to produce significant differences between testing conditions. This suggests that techniques which use a small number of terms are missing potentially valuable information. This effect could be exacerbated if the short lists contain both positive and negative emotions. For example, the relatively recent facial recognition systems for emotions depend on small lists of emotions, including many negative emotions. Thus, the use of a longer list of emotions is recommended when starting work with a new product category; this is necessary to fully present the emotional response of consumers to capture the potential emotional differences associated with the tested product.

A key factor in measurement of emotions associated with a product is whether the respondent is a product user. Commercial research depends on product users or product category users. Users produce different emotional profiles than non-users; product users have positive emotional responses to products, while non-users have more negative responses. This is in line with the inventors' results which demonstrated that consumers who like the product (score of 6 or higher on a 9 point hedonic scale) have different (more positive) emotional profiles versus respondents that do not (less than 5 on the 9 point hedonic scale). This is one of the main reasons that commercial emotion research should be expected to be different from academic emotion research involving products. When respondents are selected randomly or by convenience, rather than by product use, it would be expected that the participant group would contain both users and non-users, and the emotional profile would therefore be unfairly slanted to negative emotions.

In addition to the study of non-users, clinically oriented research sometimes aims at measuring the emotions associated with non-healthy eating behaviors. However, eating studies of non-healthy people and the resulting inclusion of negative emotion terms does not provide a good basis for studying emotions in the commercial context. The inclusion of negative terms, such as those associated with anxiety, hostility, and depression, can create a negative experience within the commercial setting. When these terms were included in the ballot, a few consumers expressed concern about why they were being asked these questions. In addition, the intensities and/or term selection for these emotions were negligible to non-existent, and they provided no incremental information. Thus, the terms associated with anxiety, hostility, and depression can be removed from the list of emotional terms.

The measurement of emotions can provide an advanced way of describing or segmenting products. Products can be labeled by the emotions they evoke; for example, some products are calming products while others are aggressive products. In addition, emotions provide a sensitive measure which differentiates products. Sometimes these are related to acceptance and sometimes they are not as previously discussed.

The emotion questionnaire which has been developed fills a gap in the absence of a published commercial emotion test. Existing questionnaires, which largely come from clinical psychiatry do not fill that gap. The newly developed facial scales also do not fill the gap in an emotion test for commercial food testing. Food use/eating by healthy consumers is a positive experience, and this requires positive emotions for measurement. Further, the facial scales depend on a small number of emotional categories, and it is recommended that a larger number of emotion terms provide more detail and differentiation of consumer response to food products. And finally, the facial scale systems require more complicated logistics which make them more demanding for the needs of the commercial test facility as well as on site, home use, and internet testing.

For some time, sensory practitioners within the commercial sector have looked for better means to connect with marketing. The measurement of emotions might help in the further connection of sensory science and marketing. The measurement of emotions also serves as a further tool to support product development. The EsSense Profile™ methodology allows for the comparison of existing products and measures the emotional response to product prototypes. In these ways, the measurement of emotions can provide a common lexicon for sensory and marketing to communicate and for product development that meet a marketing need. Emotions can be the common language to bring these areas together. Emotions help further understand some of the factors that influence food choices in consumers.

The questionnaire described herein has been presented as a starting point for testing emotions associated with foods. The questionnaire may be expanded or modified to include other traditional hedonic attributes, such as appearance and flavor acceptability of the sample, as well as diagnostic questions specific to the sample, such as Just About Right scales as shown in Meilgard et al. (Meilgard, M. C., Civille, G. V., and Carr, B. T., Sensory Evaluation Techniques, 2007. 4th Edition, Chapter 12. Affective Tests: Consumer Tests and In-House Panel Acceptance Tests).

In addition, other emotions may be included depending on the product and/or objective of the project. For example, the terms refreshed and clean may be appropriate when evaluating water or other beverages like iced tea, but may not be appropriate when evaluating emotions associated with beef stew. The method described herein may be used with products other than food, such as packaging. Terms related to the product to be evaluated should be generated and tested with consumers as described in the examples above.

Obviously, numerous modifications and variations of the present invention are possible in light of the above teachings. It is therefore to be understood that within the scope of the appended claims, the invention may be practiced otherwise than as specifically described herein.

1. A method of measuring consumer emotions associated with a targeted food product, comprising:
producing a list of emotional terms;
validating emotional terms from the list that consumers use with food products;
developing a questionnaire, using the validated emotional terms, that asks the consumers to describe their feelings associated with the targeted food product;
completing of the questionnaire by a plurality of the consumers; and
analyzing data from the completed questionnaires.

2. The method according to claim 1, wherein the questionnaire instructs the consumers to describe their feelings using a scaled response for each of the validated emotional terms.

3. The method according to claim 1, wherein the questionnaire instructs the consumers to describe their feelings by selecting one response from a five-point scale for each of the validated emotional terms.

4. The method according to claim 1, wherein the questionnaire includes a hedonic scale to evaluate overall acceptability of the targeted food product.

5. The method according to claim 1, further comprising:
determining whether each of the plurality of consumers uses the targeted food product.

6. The method according to claim 1, further comprising:
determining gender for each of the plurality of consumers.

7. The method according to claim 1, further comprising:
determining whether each of the plurality of consumers is neophobic or neophilic; and
measuring an impact that a result of the determining has on a pattern of response.

8. The method according to claim 1, wherein the validating the emotional terms comprises:
asking a group of the consumers to describe their favorite food product and their least favorite food product;
presenting the group of consumers with a list of emotions;
asking the group of consumers to describe how they felt when consuming the favorite food product and the least favorite food product by selecting one or more of the list of emotions that described their feelings;
asking the group of consumers to categorize the selected emotions into positive, negative, both positive and negative, and neither positive nor negative; and
dividing the categorized emotions into the validated emotional terms including positive, negative, and unclear groups.

9. The method according to claim 8, wherein the emotional terms associated with depression, hostility, and anxiety are excluded from the validated emotional terms.

10. The method according to claim 1, wherein the analyzing the data from the completed questionnaires includes plotting the data on a chart.

11. The method according to claim 1, further comprising:
guiding product development decisions based on the analyzed data.

12. The method according to claim 1, wherein the developing the questionnaire includes asking the consumers to describe their feelings associated with consumption of the targeted food product.

13. The method according to claim 1, wherein the developing the questionnaire includes asking the consumers to describe their feelings associated with a name of the targeted food product.

14. The method according to claim 1, wherein the developing the questionnaire includes asking the consumers to describe their feelings associated with a brand name of the targeted food product.

15. The method according to claim 1, wherein the developing the questionnaire includes asking the consumers to describe their feelings associated with a packaging of the targeted food product.

16. The method according to claim 1, wherein the developing the questionnaire includes asking the consumers to describe their feelings associated with preparation of the targeted food product.

17. The method according to claim 1, wherein the developing the questionnaire includes asking the consumers to describe their feelings associated with anticipation of consumption of the targeted food product.

18. A questionnaire for measuring consumer emotions associated with a targeted food product, comprising:
a plurality of validated emotional terms associated with the targeted food product; and
a scale next to each of the validated emotional terms for consumers to indicate the applicability of the validated emotional terms associated with the targeted food product.

19. The questionnaire according to claim 18, wherein the scale is a five-point scale.

20. The questionnaire according to claim 18, further comprising:
a hedonic scale to evaluate overall acceptability of the targeted food product.

21. The questionnaire according to claim 18, wherein the plurality of validated emotional terms consists essentially of active, adventurous, affectionate, aggressive, bored, calm, daring, disgusted, eager, energetic, enthusiastic, free, friendly, glad, good, good-natured, guilty, happy, interested, joyful, loving, marry, mild, nostalgic, peaceful, pleased, pleasant, polite, quiet, satisfied, secure, steady, tame, tender, understanding, warm, whole, wild, and worried.

22. The questionnaire according to claim 18, wherein the questionnaire includes no more than forty-five validated emotional terms, and
wherein the plurality of validated emotional terms includes at least twenty-six of the following terms:
active, adventurous, affectionate, aggressive, bored, calm, daring, disgusted, eager, energetic, enthusiastic, free, friendly, glad, good, good-natured, guilty, happy, interested, joyful, loving, marry, mild, nostalgic, peaceful, pleased, pleasant, polite, quiet, satisfied, secure, steady, tame, tender, understanding, warm, whole, wild, and worried.
